(19) United States
(12) Patent Application Publication
(10) Pub. No.: US 2020/0166696 A1
(43) Pub. Date: May 28, 2020

(54) DISPLAY DEVICE

(71) Applicant: Samsung Display Co., Ltd., Yongin-si (KR)

(72) Inventors: Jin Hyuk PARK, Hwaseong-si (KR); Won Chul LEE, Seoul (KR)

(21) Appl. No.: 16/677,149

(22) Filed: Nov. 7, 2019

(30) Foreign Application Priority Data
Nov. 26, 2018 (KR) 10-2018-0147133

(51) Int. Cl. F21V 8/00

(52) U.S. Cl. CPC G02B 6/0093; G02B 6/0055; G02B 6/0051

(57) ABSTRACT

A display device includes a light guide plate; and a mold frame surrounding the light guide plate in a plan view. The mold frame includes a main frame, a first sub-frame, and a second sub-frame. Extending along one side surface of the light guide plate in a first direction, the main frame includes a first main portion positioned at one side of the first and second sub-frames, and a second main portion positioned at the other side of the first and second sub-frames. The first sub-frame is connected to the first main portion, and the first sub-frame protrudes toward the light guide plate from the first main portion along a second direction crossing the first direction. The second sub-frame is connected to the first main portion and the second main portion, and the first sub-frame and the second sub-frame are spaced apart from each other with a space therebetween.

### CROSS-REFERENCE TO RELATED APPLICATION

This application claims priority to and the benefit of Korean Patent Application No. 10-2018-0147133, filed on Nov. 26, 2018 in the Korean Intellectual Property Office, the entire content of which is incorporated herein by reference.

### BACKGROUND

### 1. Field

One or more aspects of example embodiments of the present disclosure are related to a display device.

### 2. Description of the Related Art

A liquid crystal display (LCD) device receives light from a backlight assembly and displays an image. The backlight assembly includes a light source and a light guide plate. The light guide plate receives light from the light source and guides the transmitted light toward the display panel. In some products, the light received from the light source is white light, and the white light may be filtered by a color filter in the display panel to thereby generate a range of colors.

Recently, a variety of techniques for generating white light using a blue LED and quantum dots (QD) emitting red light and green light as phosphors have been introduced. White light generated using quantum dots has high luminance and excellent color reproducibility. However, there is still a need to reduce light loss and improve color uniformity, when quantum dots are applied to a LED backlight unit.

### SUMMARY

One or more aspects of example embodiments of the present disclosure are directed toward a display device to which a light guide plate is affixed, and which can accommodate the light guide plate even when the light guide plate expands.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

One or more example embodiments of the present disclosure provide a display device. The display device includes a light guide plate; and a mold frame surrounding the light guide plate in a plan view, wherein the mold frame includes a first sub-frame, a second sub-frame, and a main frame including: a first main portion connected to a first end of the first sub-frame and a first end of the second sub-frame and extending along (e.g., on at least a part of) a first side surface of the light guide plate along a first direction, and a second main portion connected to a second end of the second sub-frame and extending along (e.g., on at least a part of) the first side surface of the light guide plate opposite the first direction, the first sub-frame and the second sub-frame being parallel and spaced apart from each other with a space therebetween.

In some embodiments, the light guide plate may include glass and/or quartz.

In some embodiments, the first sub-frame may include a first section facing the first side surface of the light guide plate and a second portion connecting the first portion and the first main portion.

In some embodiments, a side surface of the first section of the first sub-frame portion facing the first side surface of the light guide plate may be closer to the light guide plate in a second direction normal to the first direction, compared to a side surface of the main frame facing the light guide plate.

The first sub-frame of the display device may further include a chamfered surface connecting the side surface of the first section facing the first side surface of the light guide plate and an upper surface of the first section, wherein a slope of the chamfered surface of the first section is between a slope of the side surface of the first section facing the first side surface of the light guide plate and a slope of the upper surface of the first section.

The display device may further include a color conversion tape attached to (at least a portion of) the first sub-frame and between the first section and the light guide plate.

In some embodiments, the color conversion tape may include a yellow phosphor.

In some embodiments, the color conversion tape may be attached to an entirety of a side surface of the mold frame facing the light guide plate.

In some embodiments, a density of the yellow phosphor in the color conversion tape in an area where the color conversion tape is attached to the first section may be higher than a density of the yellow phosphor in the color conversion tape in an area where the color conversion tape is attached to the main frame.

In some embodiments, the first sub-frame further may include a third portion connecting the first portion of the first sub-frame to the second main portion.

In some embodiments, the display device may further include a cushion (e.g., buffer) member disposed between the first sub-frame and the second sub-frame.

In some embodiments, the mold frame may form a rectangular frame shape in a plan view.

In some embodiments, a planar width of the main frame is greater than a planar width of the first sub-frame.

In some embodiments, the mold frame may include a light blocking material.

In some embodiments, the display device may further include a light source at a second side surface of the light guide plate; and a wavelength conversion layer on an upper surface of the light guide plate.

In some embodiments, the light source may provide blue light to the light guide plate, and

the wavelength conversion layer may include a plurality of first wavelength conversion particles to convert the blue light into red light and a plurality second wavelength conversion particles to convert the blue light into green light.

One or more example embodiments of the present disclosure provide a display device. A display device includes a light guide plate; a mold frame having a rectangular frame shape and surrounding the light guide plate in a plan view; a light source between a first side surface of the light guide plate and the mold frame; and a color conversion tape between a second side of the light guide plate, and the mold frame, wherein the mold frame includes a main portion extending along the second side of the light guide plate and a sub portion connected to the main portion and protruding toward the second side of the light guide plate with respect to the main portion, the light source being to provide blue light to the light guide plate, and the color conversion tape being attached to the sub-portion of the mold frame.

In some embodiments, the color conversion tape may include a yellow phosphor.

In some embodiments, the color conversion tape may convert the blue light into yellow light in wavelength.

In some embodiments, the color conversion tape may integrally extend along (e.g., on at least a part of) a second side surface and a third side surface (e.g., on all sides of the light guide plate other than the first side of the light guide plate).

### BRIEF DESCRIPTION OF THE DRAWINGS

The above and other aspects and features of the present disclosure will become more apparent and more readily appreciated from the following description of the example embodiments, taken in conjunction with the accompanying drawings, in which:

FIG. 1 is a schematic plan view of a display device according to an embodiment of the present disclosure;

FIG. 2 is a cross-sectional view taken along the line II-II′ in FIG. 1;

FIG. 3 is a cross-sectional view taken along the line III-III′ in FIG. 1;

FIG. 4 is a cross-sectional view taken along the line IV-IV′ in FIG. 1;

FIG. 5 is a plan view showing a case where a light guide plate expands;

FIGS. 6 and 7 are cross-sectional views illustrating variations in light paths depending on the distance between a light conversion tape and a light guide plate;

FIG. 8 is a cross-sectional view showing a modified example embodiment of a first sub-frame, taken along a line equivalent to line II-II′ in FIG. 1;

FIG. 9 is a schematic plan view of a display device according to another embodiment of the present disclosure;

FIG. 10 is a schematic plan view of a display device according to another embodiment of the present disclosure;

FIG. 11 is a cross-sectional view taken along the line XI-XI′ in FIG. 10;

FIG. 12 is a schematic plan view of a display device according to another embodiment of the present disclosure;

FIG. 13 is a schematic plan view of a display device according to another embodiment of the present disclosure;

FIG. 14 is a schematic plan view of a display device according to another embodiment of the present disclosure;

FIG. 15 is a cross-sectional view taken along the line XV-XV′ in FIG. 14;

FIG. 16 is a schematic plan view of a display device according to another embodiment of the present disclosure;

FIG. 17 is a partially enlarged view of FIG. 16;

FIG. 18 is a schematic plan view of a display device according to another embodiment of the present disclosure;

FIG. 19 is a schematic plan view of a display device according to another embodiment of the present disclosure; and

FIG. 20 is a cross-sectional view taken along the line XX-XX′ in FIG. 19.

### DETAILED DESCRIPTION

Hereinafter, embodiments of the present disclosure will be described with reference to the attached drawings.

Advantages and features of the present disclosure and methods for achieving those advantages and features will be apparent by referring to the embodiments, which will be described in more detail with reference to the accompanying drawings. However, the present disclosure is not limited to the embodiments disclosed herein, and can be implemented in diverse forms. The description, including details of construction and various elements, are provided as specific details to assist those of ordinary skill in the art in obtaining a comprehensive understanding of the present disclosure.

In the drawings, the thicknesses of layers, films, panels, regions, etc., may be exaggerated for clarity. Like reference numerals designate like elements throughout the specification. It will be understood that when an element such as a layer, film, region, or substrate is referred to as being “on” another element, it can be directly on the other element or intervening element(s) may also be present. In contrast, when an element is referred to as being “directly on” another element, no intervening elements are present.

Expressions such as “at least one of”, “one of”, and “selected from”, when preceding a list of elements, modify the entire list of elements and do not modify the individual elements of the list. Further, the use of “may” when describing embodiments of the present disclosure refers to “one or more embodiments of the present disclosure.”

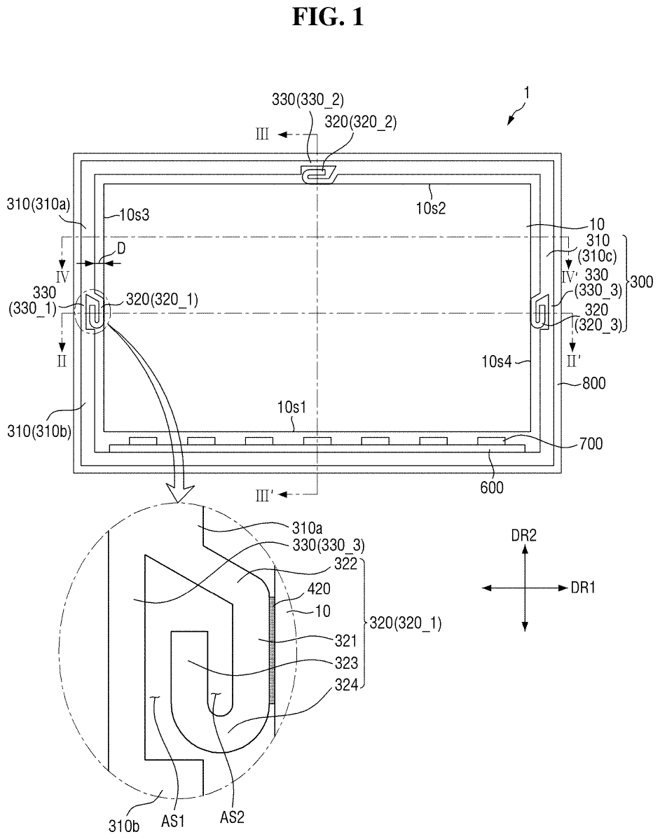

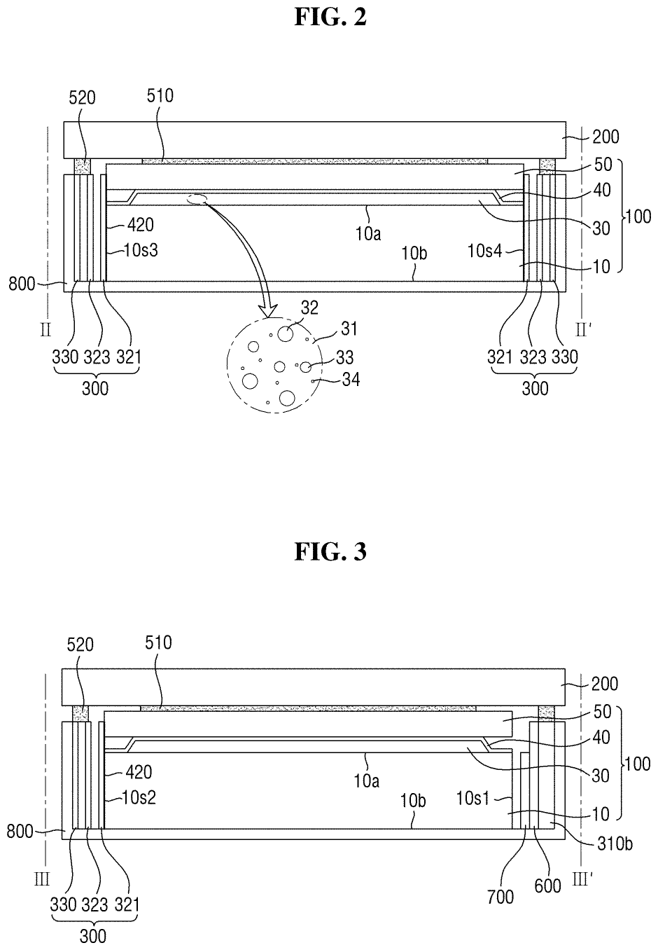

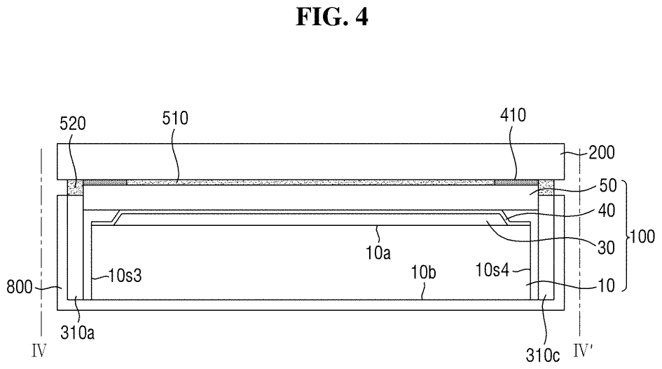

FIG. 1 is a schematic plan view of a display device according to an embodiment of the present disclosure. FIG. 2 is a cross-sectional view taken along the line II-II′ in FIG. 1. FIG. 3 is a cross-sectional view taken along the line III-III′ in FIG. 1, and FIG. 4 is a cross-sectional view taken along the line IV-IV′ in FIG. 1.

Referring to FIGS. 1 to 4, a display device 1 includes an optical member 100, a display panel 200, a mold frame 300, color conversion tapes 410 and 420, engaging members 510 and 520, a circuit board 600, a light source 700, and a housing 800.

The optical member 100 includes a light guide plate 10, a wavelength conversion layer 30 on the light guide plate 10, a passivation layer 40 on the wavelength conversion layer 30, and an optical film 50.

Unless defined otherwise, in the present specification, the “upper”, “top”, or “upper surface” refers to a side of a display surface adjacent to the display panel 200, and the “lower”, “bottom”, or “lower surface” refers to a side (surface) of the display opposite to (e.g., farthest from) the display panel 200.

The light guide plate 10 serves to guide the traveling path of light emitted from the light source 700.

As shown in FIG. 1, the planar shape of the light guide plate 10 may be a rectangular. For example, the planar shape (e.g., two-dimensional footprint) of the light guide plate 10 may be a rectangle having angled (sharp, triangular) corners or a rectangle having rounded corners. In one embodiment, the three-dimensional shape of the light guide plate 10 may be a hexagonal columnar shape. The light guide plate 10 may include four side surfaces 10s1, 10s2, 10s3, and 10s4, an upper surface 10a, and a lower surface 10b. In a plan view, the first side surface 10s1 and the second side surface 10s2 may extend along a first direction DR1, and the third side surface 10s3 and the fourth side surface 10s4 may extend along a direction DR2 crossing (e.g., normal to) the first direction DR1. The planar profile of the first side surface 10s1 and the second side surface 10s2 may be a long side of the light guide plate 10, and the planar profile of the third side surface 10s3 and the fourth side surface 10s4 may be a short side of the light guide plate 10.

However, the first direction DR1 and the second direction DR2 are relative to each other, and in some embodiments or in alternate notation, the planar extending directions of each of the side surfaces 10s1, 10s2, 10s3, and 10s4 may be switched from those described above.

The upper surface 10a and lower surface 10b of the light guide plate 10 are located on separate planes (e.g., each define a plane). The plane on which the upper surface 10a is located and the plane on which the lower surface 10b is located are substantially parallel to each other, and the entire light guide plate 10 may have a uniform thickness.

In some embodiments, the light guide plate 10 may further include a slanted surface (chamfered surface) between the upper surface 10a and each of the side surfaces 10s1, 10s2, 10s3, and 10s4 and/or between the lower surface 10b and each of the side surfaces 10s1, 10s2, 10s3, and 10s4. Accordingly, the thickness of the light guide plate 10 may gradually increase with distance from the side surface, and because the upper surface 10a and the lower surface 10a have a flat shape, the light guide plate 10 has a constant thickness in a center region of the plate. The chamfered surfaces of the light guide plate 10 may prevent or reduce the risk of an adjacent component of the display device 1 (for example, the mold frame 300) from being damaged by the edges where the upper surface 10a meets the side surfaces 10s1, 10s2, 10s3, and 10s4 and/or the lower surface 10b meets the side surfaces 10s1, 10s2, 10s3, and 10s4.

Hereinafter, an embodiment in which the upper surface 10a and/or lower surface 10b of the light guide plate 10 directly meets the side surfaces 10s1, 10s2, 10s3, and 10s4 of the light guide plate 10 without the chamfered surface (thereby forming an angle of 90°) will be described.

In some embodiments, a scattering pattern may be further provided on the lower surface 10b of the light guide plate 10 (e.g., adjacent to the light source). The scattering pattern may modify or change the traveling (transmission) angle of light traveling in the light guide plate 10 by way of total reflection, after which the light is transmitted to the outside of the light guide plate 10. When the scattering pattern is included, the density of the scattering pattern on the light guide plate 10 may vary between regions of the light guide plate 10.

The light guide plate 10 may include an inorganic material or an organic material. In some embodiments, the light guide plate 10 may be made of glass and/or quartz.

The light source 700 may provide light (a first light) to the light guide plate 10. The light source 700 may be positioned at or over at least one side surface of the light guide plate 10. In some embodiments, the light source 700 may be over the first side surface 10s1 of the light guide plate 10. In some embodiments, the light source 700 may be adjacent to (positioned at) both the first side surface 10s1 and the second side surface 10s2, or may be adjacent to (positioned at) the third side surface 10s3 and/or the fourth side surface 10s4. The light source 700 may be mounted on the circuit board 600. The circuit board 600 may be at or over the side surface of the light guide plate 10 along with the light source 700. Hereinafter, a case where the light source is positioned at or over the first side surface 10s1 of the light guide plate 10 will be mainly described.

A plurality of light sources 700 may be provided. In some embodiments, the light source 700 may be or include a light emitting diode (LED), but embodiments of the present disclosure are not limited thereto.

The first side surface 10s1 of the light guide plate 10, with the light source 700 being adjacent, may be a light incidence surface (on which light emitted from the light source 700 is directly incident), and the second side surface 10s2 facing (opposite) the first side surface 10s1 may be a light facing surface. In some embodiments, the light source 700 may be a top light emitting diode to emit light toward the upper surface of the light guide plate 10.

The light source 700 may be to emit the first light having a first wavelength range. The first light may be light having a wavelength of about 320 nm to about 420 nm. In some embodiments, the first light may be near-ultraviolet light having a wavelength of about 320 nm to about 400 nm (which is adjacent to the range of visible light wavelengths), or may be blue light having a wavelength of about 400 nm to about 420 nm (which is within the range of blue light wavelengths).

The wavelength conversion layer 30 is on the light guide plate 10. The wavelength conversion layer 30 may be to convert the wavelength of at least a portion of the light incident on the wavelength conversion layer 30. As shown in FIG. 2, the wavelength conversion layer 30 includes a binder 31, wavelength conversion particles 32 and 33, and scattering particles 34.

The binder 31 is a medium in which the wavelength conversion particles 32 and 33 are dispersed, and include any suitable resin composition.

The first wavelength conversion particles 32 may absorb and convert light (including the first light) into a second light having a peak wavelength in a second wavelength range longer than the original wavelength range of the first light. The second wavelength conversion particles 33 may absorb and convert the first light into a third light having a peak wavelength in a third wavelength range longer than the second wavelength range. In some embodiments, the first wavelength conversion particles 32 may also absorb and convert the third light into the second light.

The second wavelength range may be about 620 nm to about 670 nm, and the third wavelength range may be about 520 nm to about 570 nm. The second light may be red light, and the third light may be green light. That is, the first wavelength conversion particles 32 may be red wavelength conversion particles that convert blue light emitted by the light source 700 into red light, and/or convert green light converted by the second wavelength conversion particles 32 into red light. The second wavelength conversion particles 33 may be green wavelength conversion particles that convert blue light emitted from the light source 700 into green light. It should be understood that the blue, green, and red wavelengths are not limited to the above examples and ranges, and include all wavelength ranges that can be recognized as blue, green, and/or red in the art.

The wavelength converting particles 32 and 33 may each be composed of a quantum dot (QD) or a fluorescent material. As used herein, the term “quantum dot (QD)” refers to a material having a crystal structure of several nanometers in size (e.g., at least one length or diameter of 1 to 100 nanometers), which includes hundreds to thousands of atoms, and exhibits quantum confinement effects in which an energy band gap is increased due to the small size of the structure. When light having an energy higher than the band gap is incident on the quantum dots QDs, the quantum dots (QDs) absorb the light and enter an excited state, and subsequently emit light as they return to the ground state. The emitted light has an energy and wavelength corresponding to the energy of the QD band gap. The size and composition of the quantum dots (QDs) may be adjusted to control the luminescence characteristics of the QDs according to parameters of the quantum confinement effect.

The quantum dots (QDs) may include, for example, at least one of group II-VI compounds, II-V group compounds, group III-VI compounds, group III-V compounds, group IV-VI compounds, group compounds, group II-IV-VI compounds, and group II-IV-V compounds. For example, non-limiting examples of II-VI group compounds include CdSe, ZnSe, CdTe, ZnTe, ZnS, HgS, HgSe, HgTe, and CdZnSe. Non-limiting examples of II-V group compounds include Zn₃P₂, Cd₃P₂, and Cd₃As₂. Non-limiting examples of III-V group compounds include GaP, GaAs, GaSb, InN, InP, InAs, and InSb. Non-limiting examples of IV-VI group compounds include PbSe, PbS, PbTe, SnTe, SnSe, and PbSeS. Non-limiting examples of group compounds include materials including Group IB (e.g., Cu, Ag), Group III (e.g., Al, Ga and In), and Group VI (e.g., S, Se and Te) elements.

In some embodiments, the quantum dots (QDs) may include a core and a shell coating the core (e.g., may have a core-shell structure). The core may include, but is not limited to, at least one of CdS, CdSe, CdTe, ZnS, ZnSe, ZnTe, GaN, GaP, GaAs, GaSb, AIN, AIP, AlAs, AlSb, InP, InAs, InSb, SiC, Ca, Se, In, P, Fe, Pt, Ni, Co, Al, Ag, Au, Cu, FePt, Fe₂O₃, Fe₃O₄, Si, and Ge. The shell may include, but is not limited to, at least one of ZnS, ZnSe, ZnTe, CdS, CdSe, CdTe, HgS, HgSe, HgTe, AlN, AlP, AlAs, AlSb, GaN, GaP, GaAs, GaSb, GaSe, InN, InP, InAs, InSb, TIN, TIP, TIAs, TISb, PbS, PbSe, and PbTe.

In some embodiments, the second wavelength conversion particles 33 may be smaller than the first wavelength conversion particles 32 in size (diameter). This is due to the quantum confinement effect, in which the energy band gap becomes larger as the size becomes smaller (e.g., such that the third light emitted by the second wavelength conversion particles 33 has a larger energy and shorter wavelength than the second light emitted by the first wavelength conversion particles).

The scattering particles 34, which are non-quantum dot particles, may be particles having no wavelength conversion function (e.g., that do not absorb and convert light). The scattering particles may scatter incident light so that a larger amount (fraction) of the total light in the wavelength conversion layer 30 is subsequently incident on the wavelength conversion particles 32 and 33. In addition, the scattering particles 34 may substantially uniformly control the emission angle for each wavelength of light. For example, when a portion of the total light is incident on the wavelength conversion particles, converted, and then emitted, the emission direction of the light may be scattered at random. When scattering particles 34 are not present in the wavelength conversion layer 30, the second light and the third light emitted by the wavelength conversion particles have scattering emission characteristics (e.g., may be randomly scattered), but the first light, which is emitted directly by the OLED and is not converted by any particles, is not randomly scattered upon emission, such that the emission amounts of each light will vary, depending on the emission angle. The scattering particles 34 impart scattering emission characteristics even to the first light (which is emitted without colliding with the wavelength conversion particles), thereby standardizing or equalizing the emission angles for each wavelength of light.

The scattering particles 34 may include or be made of an inorganic material. Non-limiting examples of the inorganic material may include SiO₂, TiO₂, ZnO, SnO₂, and mixtures thereof.

The passivation layer 40 may be on the wavelength conversion layer 30. The passivation layer 40 may prevent or reduce penetration of moisture and/or oxygen (hereinafter referred to as ‘moisture/oxygen’) into the display panel. The passivation layer 40 may include or be made of an inorganic material. For example, the passivation layer 40 may include or be made of silicon nitride, aluminum nitride, zirconium nitride, titanium nitride, hafnium nitride, tantalum nitride, silicon oxide, aluminum oxide, titanium oxide, tin oxide, cerium oxide, silicon oxynitride, or one or more mixtures thereof, or may be made in the form of a metal thin film having light transmittance. In some embodiments, the passivation layer 40 may include or be made of silicon nitride. The passivation layer 40 may completely or substantially cover the wavelength conversion layer 30 on all sides (for example, the upper and all side surfaces).

In some embodiments, a low refractive layer may additionally be between the light guide plate 10 and the wavelength conversion layer 30. The low refractive layer may have a refractive index that is smaller than the refractive index of the light guide plate 10 by about 0.2 or less to help or promote total reflection of light within the light guide plate 10. For example, the refractive index of the low refractive layer 20 may be about 1.2 to about 1.4.

The optical film 50 may be over the wavelength conversion layer 30. The optical film 50 may be, for example, a prism (prismatic) film, a diffusion film, a micro lens film, a lenticular film, a polarizing film, a reflective polarizing film, ora retardation film. In some embodiments, the display device 1 may include a plurality of optical films 50, and the plurality of optical films may be of the same kind (type) or different kinds (types).

When the plurality of optical films 50 is applied, the optical films 50 may be positioned or arranged to overlap each other. The first color conversion tape 410 may be on the upper surface of the edge region of the optical film 50.

The display panel 200 may be on the optical film 50. The display panel 200 receives light from the optical member 100 and displays an image. Non-limiting examples of such a light-receiving display panel that receives light and displays an image include a liquid crystal display panel and an electrophoretic panel. Hereinafter, a liquid crystal display (LCD) panel is described as the display panel 200, but other suitable light-receiving display panels may be applied without being limited thereto.

The first engaging member 510 may be between the display panel 200 and the optical film 50. The first engaging member 510 may engage the display panel 200 with the optical film 50.

The mold frame 300 may be around the optical plate 10. The mold frame 300 may surround and be adjacent to the side surfaces 10s1, 10s2, 10s3, and 10s4 of the light guide plate 10. In some embodiments, for example when the optical plate is rectangular, the planar shape of the mold frame 300 may be a rectangular frame shape.

The second engaging member 520 may be between the mold frame 300 and the display panel 200. The second engaging member 520 may engage the mold frame 300 with the display panel 200. In some embodiments, the display panel 200 may also be directly engaged with the housing 800 through the engaging member (e.g., second engaging member 520). Other suitable configurations engaging the display panel 200 with other elements are possible.

The aforementioned circuit board 600 and light source 700 may be on (e.g., attached to) the mold frame 300 adjacent to the first side surface 10s1 of the light guide plate 10. The circuit board 600 may be directly on (e.g., attached to) one surface of the mold frame 300, the one surface facing the first side surface 10s1 of the light guide plate 10, and the light source 700 may be between the one surface of the mold frame 300 and the circuit board 600 and/or may be directly on one surface of the circuit board 600, the one surface facing the first side surface 10s1 of the light guide plate 10.

The mold frame 300 may include a light blocking material. The light blocking material may include an organic material and a light absorbing material (such as black pigment and/or black dye). The organic material may include at least one of polyethylene terephthalate, polycarbonate, polyimide, acrylic resin, epoxy resin, phenol resin, polyamide resin, polyimide resin, unsaturated polyester resin, polyphenylene resin, polyphenylene sulfide resin, and benzocyclobutene.

When the mold frame 300 includes the light blocking material, the mold frame 300 may partially absorb light incident on the mold frame 300 via the side surfaces 10s1, 10s2, and 10s3 of the light guide plate 10 that was not transmitted from the light guide plate 10 to the wavelength conversion layer 30. Thus, the mold frame 300 may partially prevent or reduce leakage of light from the edges of the display surface.

The mold frame may include a main frame 310, a first sub-frame 320, and a second sub-frame 330. Each of the main frame 310, the first sub-frame 320, and the second sub-frame 330 may include multiple (one or more) sub-portions. For example, as shown in FIG. 1, the main frame 310 may include portions 310a, 310b, and 310c; the first sub-frame 320 may include portions 320-1, 320-2, and 320-3; and the second sub-frame 330 may include portions 330-3, 330-2, and 330-3. However, embodiments of the present disclosure are not limited thereto, and the main frame 310, first sub-frame 320, and second sub-frame 330 may include any suitable number of sub-portions, depending on the configuration of the display device (for example, the number and arrangement of side surfaces).

Similarly to the mold frame 300, the main frame 310 (including sub-portions 310a, 310b, and 310c) may substantially surround the side surfaces 10s1, 10s2, 10s3, and 10s4 of the light guide plate 10. The main frame 310 may be spaced apart from each of the side surfaces 10s1, 10s2, 10s3, and 10s4 of the light guide plate 10 by a set or predetermined distance D.

The extending direction of the main frame 310 may substantially correspond to the planar shape of the light guide plate 10 (e.g., the main frame 310 may extend along and within the plane of the light guide plate 10). For example, the main frame 310 may extend along the first direction DR1 at the first side surface 10s1 and second side surface 10s2 of the light guide plate 10, and may extend along the second direction DR2 at the third side surface 10s3 and fourth side surface 10s4 of the light guide plate 10.

The main frame 310 may include a first main portion 310a, a second main portion 310b, and a third main portion 310c. The first main portion 310a may be between portions of the sub-frames 320 and 330 adjacent to the second side surface 10s2 and third side surface 10s3 of the light guide plate 10 (for example, between 320-1/330-1 and 320-2/330-2). As shown in FIG. 1, the first main portion 310a may extend in an upward direction (along DR2) from sub-frames 320-1 and 330-1 adjacent to the third side surface 10s3, and then extend in a right direction (along DR1) toward sub-frames 320-2 and 330-2 adjacent to the second side surface 10s3 of the light guide plate 10.

The second main portion 310b may be between portions of the sub-frames 320 and 330 adjacent to the third side surface 10s3, first side surface 10s1, and fourth side surface 10s4 of the light guide plate 10. The second main portion 310b may extend in the downward direction (opposite DR2) from sub-frames 320-1 and 330-1 adjacent to the third side surface 10s3, extend in the right direction (along DR1) parallel to 10s1, and then extend in the upward direction (along DR2), toward sub-frames 320-3 and 330-3 adjacent to the fourth side surface 10s4 of the light guide plate 10.

The third main portion 310c may be between sub-frames 320 and 330 adjacent to the second side surface 10s2 and fourth side surface 10s4 of the light guide plate 10. The third main portion 310c may extend in the right direction (along DR1) from sub-frames 330-2 and 330-2, and then extend in the downward direction (opposite DR2) toward sub-frames 320-3 and 330-3 adjacent to the fourth side surface 10s4 of the light guide plate 10.

The first main portion 310a may be on one side of the sub-frames 320 and 330 (e.g., 320-1, 330-1) adjacent to the third side surface 10s3 of the light guide plate 10, and the second main portion 310b may be on the other side of the sub-frames 320 and 330 (e.g., 320-1, 330-1). The second sub-frame 330 (e.g., 330-1) may be connected to (e.g., continuous with) the first main portion 310a and the second main portion 310b (e.g., via a first end and a second end, respectively), and the first sub-frame 320 (e.g., 320-1) may be connected to (e.g., continuous with) the first main portion 310a (e.g., via a first end). In some embodiments, for example, the first sub-frame 320 (e.g., 320-1) may be connected only to the first main portion 310a.

Further, the third main portion 310c may be on one side of the sub-frames 320 and 330 (e.g., 320-2, 330-2) adjacent to the second side surface 10s2 of the light guide plate 10, and the first main portion 310a may be on the other side of the sub-frames 320 and 330 (e.g., 320-2, 330-2). The second sub-frame 330 (e.g., 330-2) may be connected to the first main portion 310a and the third main portion 310c (e.g., via a first end and a second end, respectively), and the first sub-frame 320 (e.g., 320-2) may be connected to the third main portion 310c (e.g., via a first end).

Similarly, the third main portion 310c may be on one side of the sub-frames 320 and 330 (e.g., 320-3, 330-3) adjacent to the third side surface 10s3 of the light guide plate 10, and the second main portion 310b may be disposed on the other side of the sub-frames 320 and 330 (e.g., 320-3, 330-3). The second sub-frame 330 (e.g., 330-3) may be connected to the second main portion 310b and the third main portion 310c (e.g., via a first end and a second end, respectively), and the first sub-frame 320 (e.g., 330-3) may be connected to the third main portion 310c (e.g., via a first end).

As used herein, the terms “one side” and “other side” of each portion of the sub-frames 320 and 330 are understood to be relative to the main portions 310a, 310b and 310c of the mold frame 300, and may thus be variously interchanged without being limited to the aforementioned terms. Similarly, the terms “first end” and “second end” may be used interchangeably without being limited to the above descriptions.

The sub-frames 320 and 330 are connected to the main frame 310. Portions of the sub-frames 320 and 330 may be interposed between portions of the main frame 310. The sub-frames 320 and 330 may be physically connected to at least one portion of the main frame 310. For example, as discussed above, parallel portions of the sub-frames 320 and 310 may be positioned between two portions of the main frame 310.

As described above, the second sub-frame 330 may be physically connected to the adjacent main frame 310.

The second sub-frame 330 may extend in substantially the same direction(s) as the adjacent main frame 310. For example, the portions of the second sub-frame 330 positioned between portions of the main frame 310 facing the first side surface 10s1 and second side surface 10s2 of the light guide plate 10 (e.g., extending along the first direction DR1) may also extend along the first direction DR1, and portions of the second sub-frame 330 between portions of the main frame 310 facing the third side surface 10s3 and fourth side surface 10s4 of the light guide plate 10 (e.g., extending along the second direction DR2) may extend along the second direction DR2.

In a plan view, the width of the second sub-frame 330 in a direction normal to the light guide plate 10 may be smaller than the width of the main frame 310 normal to the light guide plate 10. However, embodiments of the present disclosure are not limited thereto.

The first sub-frame 320 may branch from the main frame 310 in one direction. The first sub-frame 320, as described above, is positioned between portions of the adjacent main frame 310. Here, the first sub-frame 320 may be connected to one of the adjacent portions of the main frame 310 (e.g., via a first end), but may not be connected to the other one thereof (e.g., there may be a space between the second end of the first sub-frame and the main frame 310).

The first sub-frame 320 may be closer to the side surfaces 10s1, 10s2, 10s3, and 10s4 of the light guide plate 10 than the main frame 310 (e.g., may be separated from the side surfaces 10s1, 10s2, 10s3, and 10s4 of the light guide plate 10 by a distance smaller than D). For example, as shown in the expanded portion of FIG. 1, the distance between the first sub-frame 320 and the third side surface 10s3 of the light guide plate 10 may be smaller than the distance between the main frame 310 (310a) and the third side surface 10s3 of the light guide plate 10. That is, the first sub-frame 320 may protrude inward toward each of the side surfaces 10s2, 10s3, and 10s4 of the light guide plate 10 to a larger extent than the main frame 310.

The first sub-frame 320 may serve as a guide when assembling the light guide plate 10 into the mold frame 300. For example, during assembly of the light guide plate 10, the side surfaces 10s3 and 10s4 of the light guide plate 10 may be between the first sub-frames 320 protruding toward the side surfaces 10s3 and 10s4 of the light guide plate 10 from the main frame 310, respectively. Thus, the side surfaces 10s3 and 10s4 of the light guide plate 10 may be engaged with the mold frame 300 through the adjacent first sub-frame 320.

The first sub-frame 320 may prevent or reduce the light guide plate 10 from moving even after the light guide plate 10 is assembled into the mold frame 300.

Moreover, the widths of portions of the first sub-frame 320 protruding toward the side surfaces 10s2, 10s3, and 10s4 of the light guide plate 10 may be substantially the same as each other. For example, when each of the side surfaces 10s2, 10s3, and 10s4 of the light guide plate 10 are engaged with the first sub-frame 310 having the same width, the distance D between each of the side surfaces 10s2, 10s3, and 10s4 of the light guide plate 10 and the main frame 310 adjacent thereto may be substantially the same (equal). That is, the distance D between each of the second to fourth side surfaces 10s2, 10s3, and 10s4 of the light guide plate 10 and the main frame 310 adjacent thereto is maintained equal, thereby center-aligning the light guide plate 10 in the mold frame 300.

The distance D between the side surface of the light guide plate 10 and the main frame 310 adjacent thereto affects the leakage of light emitted from the light source 700. As the distance D between the side surface of the light guide plate 10 and the main frame 310 adjacent thereto increases, the amount of light transmitted from the side surfaces 10s2, 10s3, and 10s4 of the light guide plate 100 toward the display panel without contacting the mold frame 300 may increase.

As described above and shown in e.g., FIG. 4, the first color conversion tape 410 may be on or at an edge portion on the optical film 50, and may be on one side of the first engagement member 510. The first color conversion tape 410 may include an adhesive member attached to the optical film 50, a substrate between the adhesive member and the display panel 200, and color conversion particles dispersed in the substrate. The substrate may be a medium in which the color conversion particles are dispersed. The color conversion particles may include yellow phosphor. In some embodiment, the color conversion particles may include green quantum dots and red quantum dots.

The first color conversion tape 410 may be a single-sided tape.

In some embodiments, the first color conversion tape 410 may be in an area (areas) adjacent to the main frame 310, but may not be in an area (areas) adjacent to the first sub-frame 320. In some embodiments, the first color conversion tape 410 may be along the edge area (e.g., the entire edge area) of the optical film 50 regardless of whether the main frame 310 and the first sub-frame 320 are adjacent to the optical film.

The color of light travelling toward the display panel 200 may be converted or changed by the first color conversion tape 410. That is, the light emitted from the light source 700 (for example, blue light) is directly introduced into the optical film 50 without contacting the mold frame 300, and the color of the light may be converted by the first color conversion tape 410 attached to the edge of the optical film 50. The first color conversion tape 410 may be a yellow tape. When the first color conversion tape 410 converts blue light into white light, it is possible to prevent or reduce a display failure in which a blue color is visible at the edge of a display surface.

However, as described above, as the distance between the side surface of the light guide plate 10 and the main frame 310 adjacent thereto is increased, the amount of blue light leakage toward the edge of the adjacent main frame 310 increases, and thus the blue light visible on the display surface may be non-uniform. For example, even when the first color conversion tape 410 is attached to the edge of the display surface, the amount of leakage of blue light may be partially different (e.g., may vary along the edge), resulting in secondary display failure (e.g., unwanted display characteristics).

In the present embodiment, when the first sub-frame 320 is employed, as described above, the distance between each of the side surfaces 10s2, 10s3, and 10s4 of the light guide plate 10 and the main frame adjacent thereto is maintained at the same level (equalized and stabilized), such that substantially the same amount of blue light leaks from the edge of the display surface, so that it is possible to prevent or reduce display failure using the first color conversion tape 410 disposed on the optical film 200 adjacent to the main frame 310.

The first sub-frame 320 may be separated from the second sub-frame 330 (e.g., there may be a space between the first sub-frame 320 and the second sub-frame 330).

The first sub-frame 320 may include first to fourth sections 321, 322, 323, and 324.

The first section 321 of the first sub-frame 320 may include a side (an inner side) closest to each of the side surfaces 10s1, 10s2, 10s3, 10s4 of the adjacent light guide plate 10. The first section 321 of the first sub-frame 320 may be substantially parallel to the second sub-frame 330, and an outer side of the first section 321 of the first sub-frame 320 may face the second sub-frame 330. For example, as shown in FIG. 1, the planar profile of the first section 321 of the first sub-frame 320 may have a substantially linear shape.

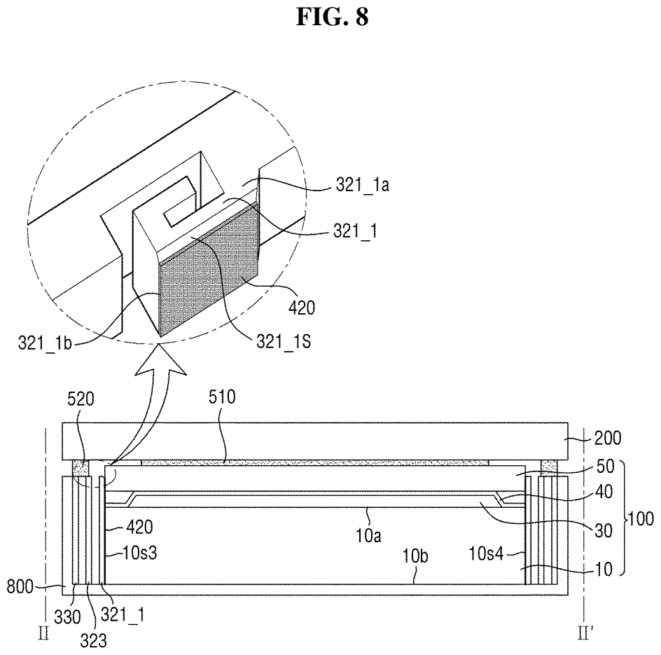

FIG. 8 is a cross-sectional view showing a modified example of a first sub-frame.

In some embodiments, as shown in FIG. 8, the first section 321 (321_1) of the first sub-frame 320 may further include a chamfered surface 321_1S between the upper surface of the first section 321 (321_1) and the side surface of the first section 321 (321_1) facing the side surface of the light guide plate 10.

The chamfered surface 321_1S of the first section 321_1 of the first sub-frame 320 may be similar to the aforementioned chamfered surface of the light guide plate 10. That is, the first section 321_1 of the first sub-frame 320 includes an upper surface 321_1a and a side surface 32_1b. The chamfered surface 3211S may connect the upper surface 321_1a and the side surface 321_1b. The inclination (slope) of the chamfered surface 321_1S of the first sub-frame 320 may be between the inclination (slope) of the side surface of the first section 321_1 of the first sub-frame 320 and the inclination (slope) of the upper surface of the first section 321_1 of the first sub-frame 320.

When the first section 321 (321_1) of the first sub-frame 320 includes the chamfered surface 321_1S, it may be easier to assemble the light guide plate 10 to the mold frame 300.

Referring to FIG. 1, the second section 322 of the first sub-frame 320 may be between the first section 321 of the first sub-frame 320 and the main frame 310. For example, the second section 322 of the first sub-frame 320 may link or connect the first section 321 of the first sub-frame 320 and the main frame 310 to each other. That is, one (a first) end of the second section 322 of the first sub-frame 320 may be connected to the main frame 310, and the other end thereof (a second end opposite the first end) may be connected to the first section 321 of the first sub-frame 320.

As shown in FIG. 1, the second section 322 of the first sub-frame 320 may extend from the main frame 310 to the first section 321 of the first sub-frame 310 in a diagonal direction, for example, in a right downward direction.

The distance between one end of the second section 322 of the first sub-frame 320 and each of the side surfaces 10s1, 10s2, 10s3, and 10s4 of the light guide plate 10 may be larger than the distance between the other end of the second section 322 of the first sub-frame 320 and each of the side surfaces 10s1, 10s2, 10s3, and 10s4 of the light guide plate 10. Further, since the second section 322 of the first sub-frame 320 extends along a right downward direction, the distance from the second section 322 to each of the side surfaces 10s1, 10s2, 10s3, and 10s4 of the adjacent light guide plate 10 may gradually vary or increase (decrease).

In some embodiments different from the embodiment shown in FIG. 1, however, the second section 322 of the first sub-frame 320 may extend in a non-diagonal direction crossing the extending direction of the first section 321 of the first sub-frame 320, so as to be connected to the first section 321 of the first sub-frame 320. In this case, the distance between the second section 322 of the first sub-frame 320 and each of the side surfaces 10s1, 10s2, 10s2, 10s3, and 10s4 of the light guide plate 10 may be made generally constant.

The third section 323 of the first sub-frame 320 may be between the first section 321 of the first sub-frame 320 and the second sub-frame 330. The third section 323 of the first sub-frame 320 may be (extend) substantially parallel to the first section 321 of the first sub-frame 320 and the second sub-frame 330. For example, as shown in FIG. 1, the planar profile of the third section 323 of the first sub-frame 320 may have a substantially linear shape.

The fourth section 324 of the first sub-frame 320 may be between the first section 321 of the first sub-frame 320 and the third section 323 of the first sub-frame 320. The fourth section 324 of the first sub-frame 320 may connect the first section 321 of the first sub-frame 320 and the third section 323 of the first sub-frame 320 to each other. That is, one end of the fourth section 324 of the first sub-frame 320 may be connected to the first section 321 of the first sub-frame 320, and the other end thereof may be connected to the third section 323 of the first sub-frame 320.

As shown in FIG. 1, the fourth section 324 of the first sub-frame 320 may have an outwardly curved shape in a plan view, but in some embodiments, may have a linear shape, without being limited thereto.

A first space AS1 may be between the first sub-frame 320 and the second sub-frame 330. For example, as shown in FIG. 1, the first space AS1 may be between the third section 323 of the first sub-frame 320 and the second sub-frame 330. Further, a second space AS2 may be between the first section 321 of the first sub-frame 320 and the third section 323 of the first sub-frame 320.

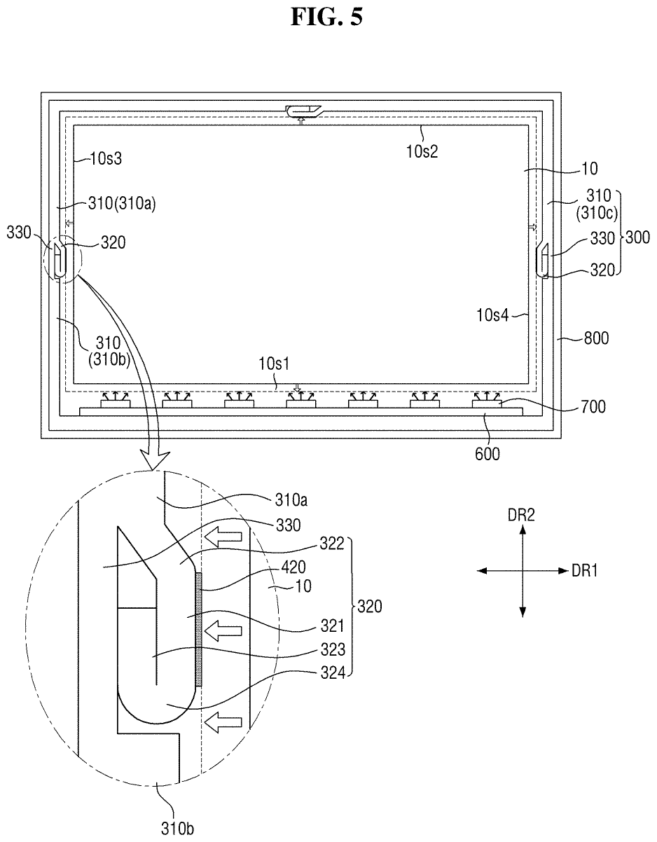

The light guide plate 10 may be expanded by heat, for example, heat generated by the first light emitted from the light source 700. Additional details will be described with reference to FIG. 5.

FIG. 5 is a plan view showing a case where a light guide plate expands.

Referring to FIG. 5, the light guide plate 10 may thermally expand by the first light emitted from the light source 700. For example, the side surfaces 10s1, 10s2, 10s3, and 10s4 of the light guide plate 10 may expand outward (toward the mold frame 300).

As described above, the mold frame 300 may include the first space AS1 and the second space AS2. Therefore, when the side surfaces 10s1, 10s2, 10s3, and 10s4 of the light guide plate 10 e expand outward (as shown by the arrows), the first space AS1 between the third section 320 of the first sub-frame 320 and the second sub-frame 330 may be reduced, and then the second space AS2 between the first section 321 of the first sub-frame 320 and the third section 323 of the first sub-frame 320 may be reduced.

When the light guide plate 10 expands outward to the maximum or largest extent, the third section 323 of the first sub-frame 320 and the second sub-frame 330 may be brought into contact with each other, and the third section 323 of the first sub-frame 320 and the first section 321 of the first sub-frame 320 may be brought into contact with each other.

For example, when the light guide plate 10 is thermally expanded outward, the first space AS1 and the second space AS2 are gradually reduced, and thus it may possible to accommodate the outwardly expanded light guide plate 10. Therefore, damage to the mold frame 300 and/or the light guide plate 10 due to thermal expansion of the light guide plate 10 can be prevented or reduced.

The second color conversion tape 420 may be between the mold frame 300 and the light guide plate 10.

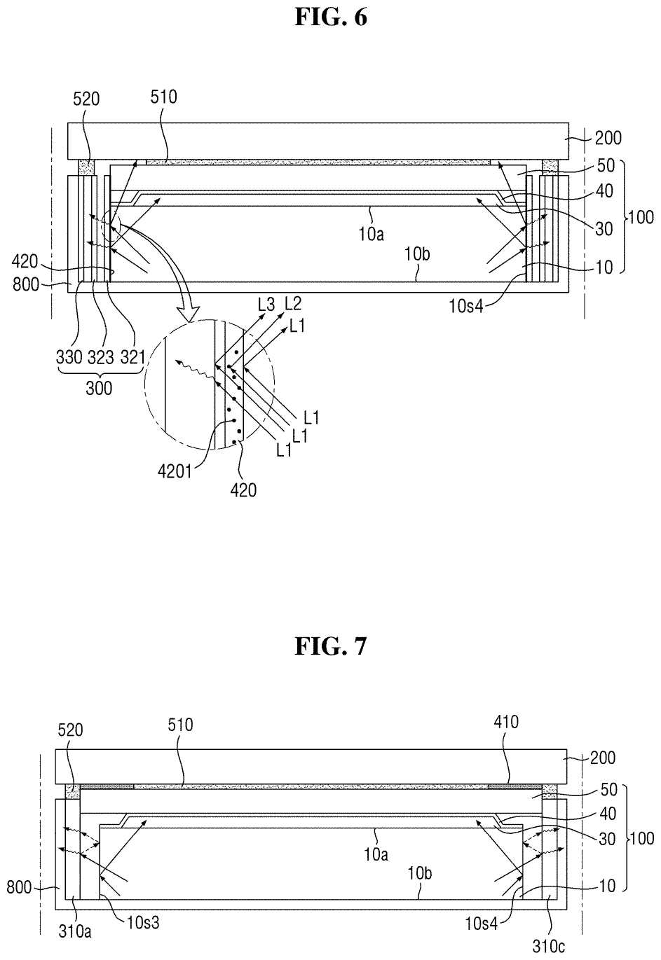

The second color conversion tape 420 may be in direct contact with the side surfaces 10s2, 10s3, and 10s4 of the light guide plate 10. The second color conversion tape 420, similarly to the aforementioned first color conversion tape 410, may include an adhesive member attached to the mold frame 300 and a substrate between the adhesive member and the side surface of the light guide plate 10. The second color conversion tape 420 may be a yellow tape. The second color conversion tape 420 may convert blue light into white light. The second color conversion tape 420 may be on the side surface of the first sub-frame 310, facing the light guide plate 10. Additional details will be described with reference to FIGS. 6 and 7.

FIGS. 6 and 7 are cross-sectional views showing various light paths, as affected by the distance between a light conversion tape and a light guide plate.

Referring to FIG. 7, the first light L1 traveling to the third side surface 10s3 of the light guide plate 10 may come in contact with air between the third side surface 10s3 of the light guide plate 10 and the main frame 310. When the first light L1 is incident on the interface between the air and the third side surface 10s3 of the light guide plate 10 at an angle greater than or equal to the critical angle, the light L1 may be totally internally reflected (without being wavelength-converted), and may then be transmitted to the wavelength conversion layer 30.

However, when the first light L1 is incident on the same air/10s3 interface at an angle less than the critical angle, the light may be transmitted through the interface and then may be incident on the adjacent main frame 310. Since the mold frame 300 includes a light blocking material as described above, about 80% of the first light incident on the adjacent main frame 310 may be absorbed by the main frame 310.

About 20% of the transmitted first light L1 is reflected by the mold frame 300. At this time, the first light L1 is partially absorbed by the light blocking material and is converted into dark light (e.g., the color of the light blocking material). The dark light is transmitted differently depending on the distance between the first section 321 of the first sub-frame 320 and each of the side surfaces 10s2, 10s3, 10s4 of the light guide plate 10. As shown in FIG. 7, a considerable amount of the dark light is diffused at the interface between the side surfaces (10s2, 10s3, and 10s4 of the light guide plate 10) and air, as well as the interface between air and the main frame 310. As such, the amount of light traveling toward the display surface is not large, and the possibility of the light being visually observed through the display surface may not be large.

On the other hand, as shown in FIG. 6, the first light L1 transmitted toward the side surfaces 10s2, 10s3, and 10s4 of the light guide plate 10 may first be incident on the second light conversion tape 420. When the mold frame 300 includes a light blocking material as described above, about 80% of the first light L1 entering the adjacent first sub-frame 320 may be absorbed by the first sub-frame 320, and about 20% of the first light L1 is reflected by the surface of the second color conversion tape 420, a phosphor 4201 included in the second color conversion tape 420, and the first sub-frame 320.

In the case of FIG. 6, as compared with FIG. 7, the distance between the first sub-frame 320 and each of the side surfaces 10s2, 1053, 10s4 of the light guide plate 10 is small, such that scattering is reduced and the possibility that the light is visually observed through the display surface may be large. However, in this embodiment, the second color conversion tape 420 may be between each of the side surfaces 10s2, 10s3, and 10s4 of the light guide plate 10 and the first sub-frame 320, and may be in direct contact with the side surfaces 10s2, 10s3, and 10s4 of the light guide plate 10.

As such, a part of the first incident light L1 may be color-converted into white light by the phosphor 4201 in the second color conversion tape 420. Accordingly, the display issue in which dark light is visually observed on the display surface near the first sub-frame 320 may be resolved.

Referring to FIGS. 1 to 4 again, the housing 800 may be outside the mold frame 300. The housing 800 may serve to mount the mold frame 300 and the optical member 100.

Hereinafter, additional embodiments of the present disclosure will be described. In the following embodiments, descriptions of elements having the same configuration as in previously described embodiments may be omitted or simplified in order to describe differences in more detail.

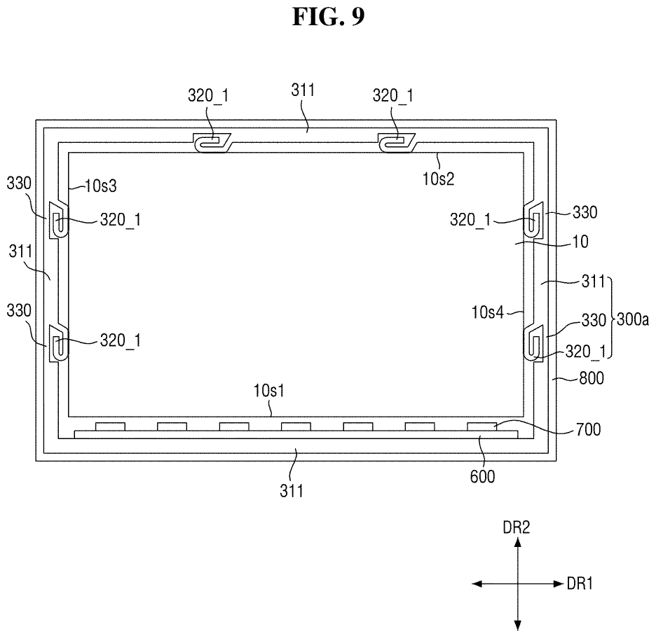

FIG. 9 is a schematic plan view of a display device according to another embodiment of the present disclosure.

Referring to FIG. 9, a display device 300a (like 300) including a main frame 311, a first sub-frame 320_1, and a second sub-frame 330 according to the present embodiment differs from the display device according to the embodiments of FIGS. 1 to 4 in that a plurality of first sub-frames 320_1 are on the side surfaces 10s2, 10s3, and 10s4 of the light guide plate 10, with multiple (two) sub-frames being adjacent to each of the side surfaces 10s2, 10s3, and 10s4. The multiplicity of sub-frames is not limited thereto, and in some embodiments, may include other multiples. The present embodiment may function or have similar effects as the embodiment of FIGS. 1 to 4.

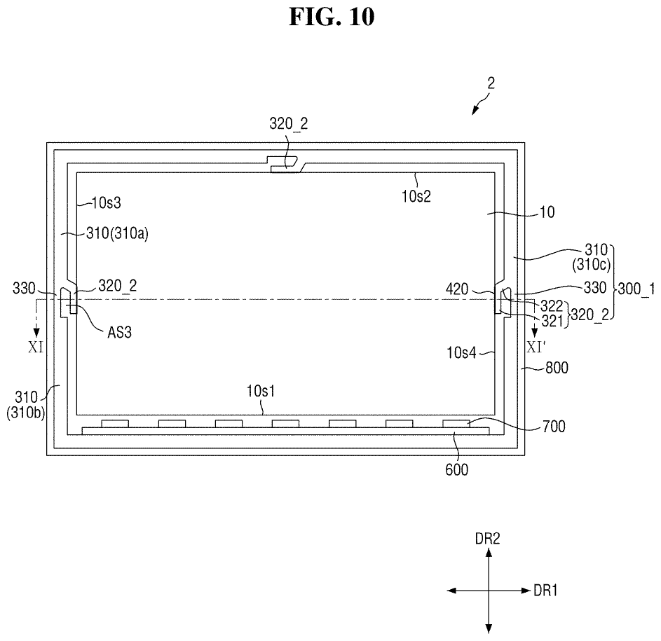

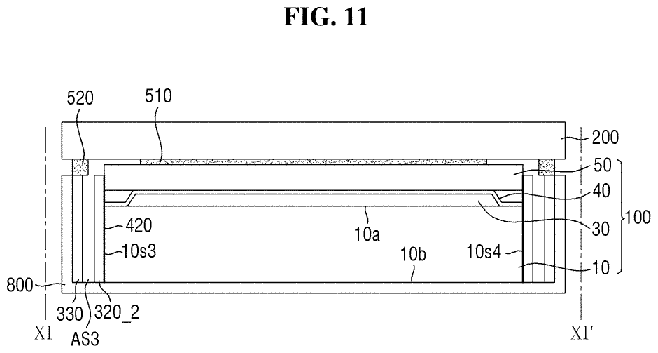

FIG. 10 is a schematic plan view of a display device 2 according to still another embodiment of the present disclosure, and FIG. 11 is a cross-sectional view taken along the line XI-XI′ in FIG. 10.

Referring to FIGS. 10 and 11, a mold frame 300_1 (including the main frame 310, a first sub-frame 320_2, and the second sub-frame 330) according to the present embodiment differs from the mold frame 300 according to FIGS. 1 to 4 in that the first sub-frame 320_2 only includes the first and second sections 321 and 322, and does not include the third and fourth sections 323 and 324.

For example, the first sub-frame 320_2 and the second sub-frame 330 may be apart from each other with a space AS3 therebetween. The mold frame 300 according to FIGS. 1 to 4 includes the first and second spaces AS1 and AS2, whereas the mold frame 300_1 according to the present embodiment may include one space, AS3. The width of the space AS3 according to the present embodiment may be larger than the widths (e.g., combined widths) of the first and second spaces AS1 and AS2. As such, the damage to the mold frame 300_1 and/or the light guide plate 10 due to the thermal expansion of the light guide plate 10 can be prevented or reduced.

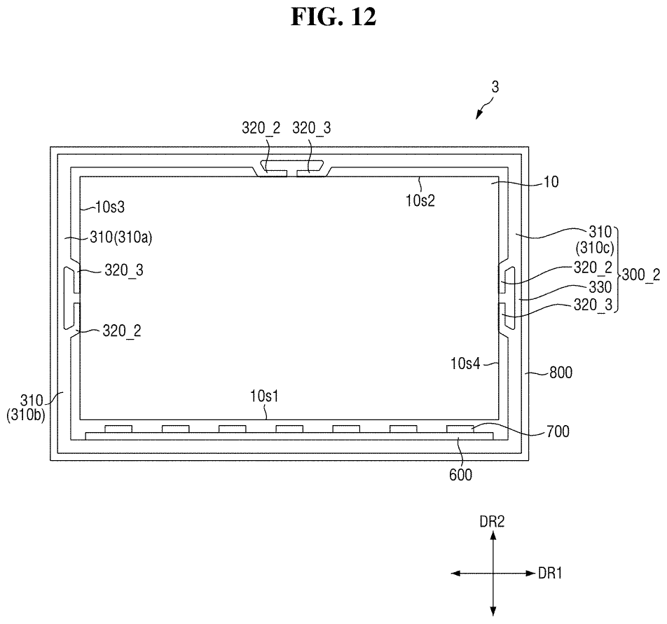

FIG. 12 is a schematic plan view of a display device 3 according to still another embodiment of the present disclosure.

Referring to FIG. 12, a mold frame 300_2 (including the main frame 310 and the second sub-frame 330) according to the present embodiment differs from the mold frame 300_1 in FIGS. 10 and 11 in that the mold frame 300_2 includes a plurality of first sub-frames 320_2 and 320_3 (e.g., the portion of the first sub-frame is split into two parts).

For example, each of the first sub-frames (first sub-frame parts) 320_2 and 320_3 may include the first section 321 and the second section 322 as described above. Further, as shown in FIG. 12, the first sub-frames 320_2 and 320_3 on the side surfaces 10s2, 10s3, and 10s4 of the light guide plate 10 may face each other along the extending direction of the fourth side surface 10s4 of the light guide plate 10. For example, the first sections 321 of the first sub-frames 320_2 and 320_3 may face (e.g., mirror) each other.

Since the first sections 321 of the first sub-frames 320_2 and 320_3 face (mirror) each other, when the light guide plate 10 thermally expands, the side surfaces 10s1, 10s2, 10s3, and 10s4 of the light guide plate 10 may extend outward, and the first sub-frames 320_2 and 320_3 may be in contact with each other. For example, the respective first sections 321 may be connected to each other. When the light guide plate 10 subsequently thermally contracts, the respective first sections 321 connected to each other may separate from each other.

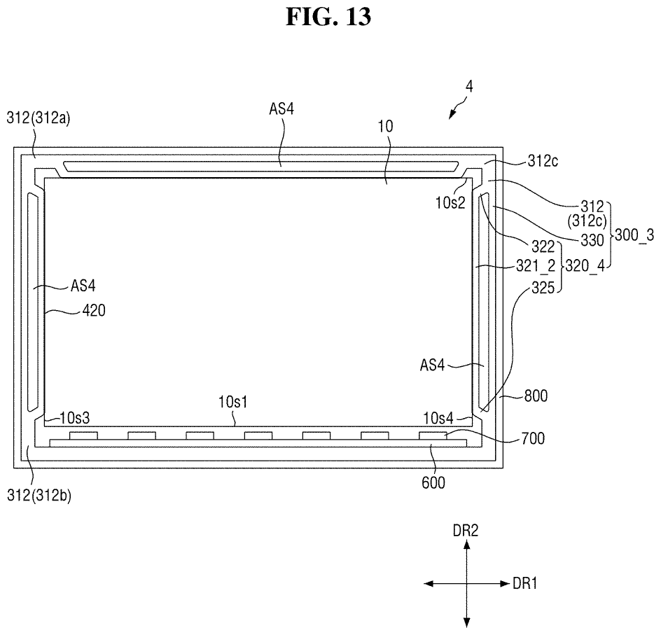

FIG. 13 is a schematic plan view of a display device 4 according to still another embodiment of the present disclosure.

Referring to FIG. 13, a mold frame 300_3 includes a main frame 312, a first sub-frame 320_4, and a second sub-frame 330. The first sub-frame 320_4 according to the present embodiment differs from the first sub-frame 320 according to FIGS. 1 to 4 in that the first sub-frame 320_4 includes a fifth (e.g., alternate third) section 325, and the area (length) of the first section 321_2 is increased.

For example, the first sub-frame 320_4 may include the first section 321_2, the second section 322, and the fifth (e.g., alternate third) section 325. The first section 321_2 is substantially the same as the first section 321 of the FIGS. 1 to 4, but the area of the first section 321_2 is increased to mostly cover the side surfaces 10s2, 10s3, and 10s4 of the light guide plate 10.

The second section 322 of the first sub-frame 320_4 may connect the first section 321_2 of the first sub-frame 320_4 and the adjacent main frame 310.

The fifth (e.g., alternate third) section 325 of the first sub-frame 320_4, similarly to the first section 321_2 and second section 322 of the first sub-frame 320_4, serves to connect adjacent main frames 312 (where 312 is substantially similar to 310). That is, one end (a first end) of the first section 321_2 of the first sub-frame 320_4 may be connected to the second section 322 of the first sub-frame 320_4, and the other end thereof (a second end opposite the first end) may be connected to the fifth (e.g., alternate third) section 325 of the first sub-frame 320_4. Further, one end (a first end) of the fifth (e.g., alternate third) section 325 of the first sub-frame 320_4 may be connected to the first section 321_2 of the first sub-frame 320_4, and the other end thereof (a second end opposite the first end) may be connected to a first portion of the adjacent main frame 312 (e.g., 321b). Meanwhile, one end (a first end) of the second section 322 of the first sub-frame 320_4 may be connected to the first section 321_2 of the first sub-frame 320_4, and the other end thereof (a second end opposite the first end) may be connected to a second portion of the adjacent main frame 312 (e.g., 312c).

That is, the first sub-frame 320_4 may connect the adjacent main frame portions 312.

A space AS4 may be between the first section 321_2 of the first sub-frame 320_4 and the second sub-frame 330.

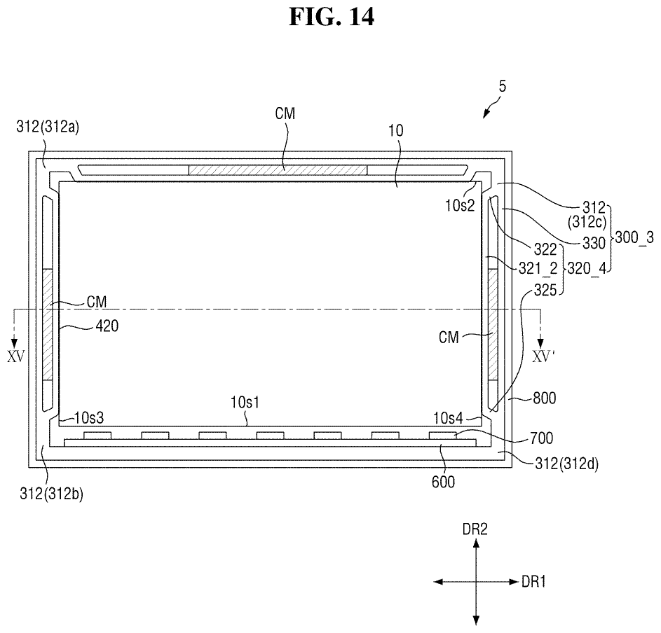

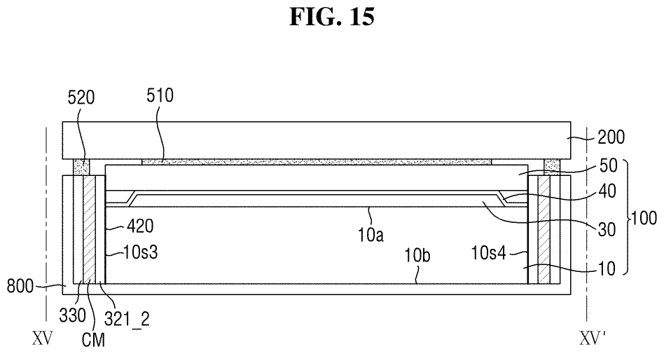

FIG. 14 is a schematic plan view of a display device according to still another embodiment of the present disclosure, and FIG. 15 is a cross-sectional view taken along the line XV-XV′ in FIG. 14.

Referring to FIGS. 14 and 15, a display device 5 according to the present embodiment differs from the display device 4 according to FIG. 13 in that the display device 5 further includes a cushion (e.g., buffer) member CM in the space between the first section 321_2 of the first sub-frame 320_4 and the second sub-frame 330 (e.g., within the space AS4).

For example, the display device 5 may further include a cushion member CM in the space between the first section 321_2 of the first sub-frame 320_4 and the second sub-frame 330.

The cushion member may absorb an impact force to prevent or reduce the mold frame 300_3 from being damaged by an external impact. The cushion member CM may be composed of a single layer or a plurality of laminated films. The cushion member CM may be made of a material having elasticity (such as polyurethane and/or polyethylene resin). The cushion member CM may be a cushion layer.

Meanwhile, when the light guide plate 10 thermally expands outward, the width of each of the second section 322 and fifth section 325 of the first sub-frame 320_4 normal to the light guide plate 10 are larger than that of the first section 321_2 of the first sub-frame 320_4, and thus resistance to an external force in those regions may be large. Accordingly, in the absence of a cushion member CM, the first section 321_2 of the first sub-frame 320_4 may be further tilted away from the light guide plate 10 compared to the second section 322 and fifth section 325 of the first sub-frame 320_4, so that the distance between the first section 321_2 of the first sub-frame 320_4 and each of the side surfaces 10s2, 10s3, and 10s4 of the light guide plate 10 may become larger than the distances between each of the second section 322 and fifth section 325 of the first sub-frame 320_4 and each of the side surfaces 10s2, 10s3, 10s4 of the light guide plate 10. Therefore, the first section 321_2 of the first sub-frame 320_4 may not be able to adequately perform the center aligning function of the light guide plate 10.

However, in the present embodiment, the cushion member CM is provided between the first section 321_2 of the first sub-frame 320_4 and the second sub-frame 330, thereby solving the problem that the first section 321_2 of the first sub-frame 320_4 may be further tilted away from the light guide plate 10 compared to the second section 322 and fifth section 325 of the first sub-frame 320_4.

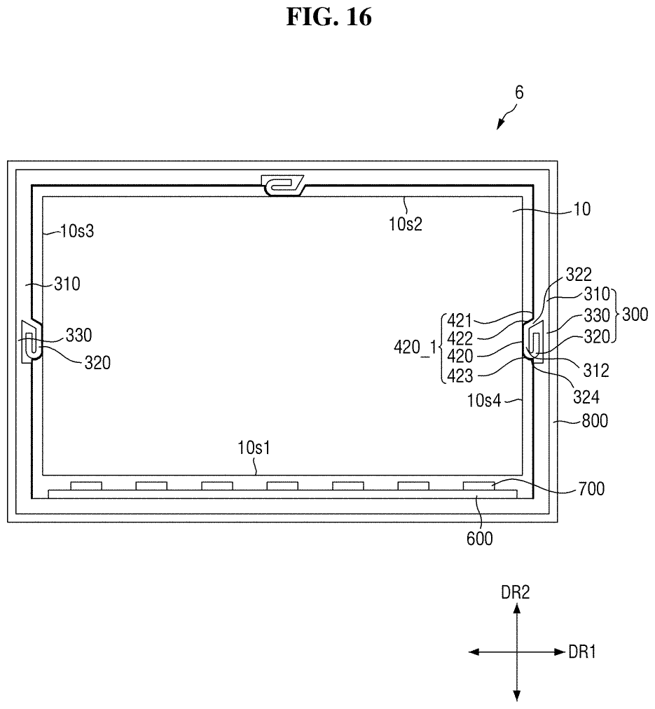

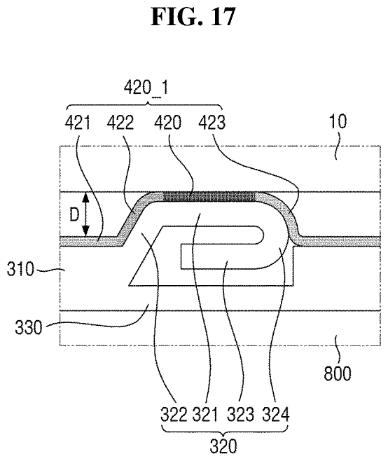

FIG. 16 is a schematic plan view of a display device 6 according to still another embodiment of the present disclosure, and FIG. 17 is a partially enlarged view of FIG. 16.

Referring to FIGS. 16 and 17, a second color conversion tape 420_1 differs from the second color conversion tape 420 of FIGS. 1 to 4 in that the second color conversion tape 420_1 is attached to the entire inner surface of the mold frame 300 (e.g., the surface adjacent to the light guide plate 10.

For example, the second color conversion tape 420_1 may be on or over (e.g., may integrally extend along or on) the inner surfaces of the main frame 310 and the first sub-frame 320 in their entirety. From another perspective, the second color conversion tape 420_1 may integrally extend along a first side surface, second side surface, and third side surface of the light guide plate, for example, on 10s2 along the direction DR1, on 10s3 along the direction DR2, and on 10s4 along the direction DR2 as depicted in FIG. 16. For example, the second color conversion tape 420_1 may substantially be on all side surface of the light guide plate except for the side surface that is adjacent to the light source 700.

In the second color conversion tape 420_1, as shown in FIG. 17, the local phosphor density may be adjusted depending on the space between the first sub-frame 320 and each of the side surfaces 10s1, 10s2, 10s3, and 10s4 of the light guide plate 10. For example, as described above in the exemplified embodiment, the second color conversion tape 420_1 may be a yellow tape for converting blue light into yellow light. The second color conversion tape 420_1 may include a first portion 420, a second portion 421, a third portion 422, and a fourth portion 423.

The first portion 420 of the second color conversion tape 420_1 may be between the first section 321 of the first sub-frame 320 and each of the side surfaces 10s2, 10s3, and 10s4 of the light guide plate 10. The second portion 421 of the second color conversion tape 420_1 may be between the main frame 310 and each of the side surfaces 10s2, 10s3, and 10s4 of the light guide plate 10. The third portion 422 of the second color conversion tape 420_1 may be between the second section 322 of the first sub-frame 320 and each of the side surfaces 10s2, 10s3, and 10s4 of the light guide plate 10. The fourth portion 423 of the second color conversion tape 420_1 may be between the fourth section 324 of the first sub-frame 320 and each of the side surfaces 10s2, 10s3, and 10s4 of the light guide plate 10.

The phosphor density of the first portion 420 of the second color conversion tape 420_1 may be greater than the phosphor density of each of the second portion 421, third portion 422, and fourth portion 423 of the second color conversion tape 420_1. The phosphor densities of the third portion 422 and the fourth portion 423 of the second color conversion tape 420_1 may each have a value between the phosphor density of the first portion 420 of the second color conversion tape 420_1 and the phosphor density of the second portion 421 of the second color conversion tape 420_1.

As described above with reference to FIGS. 6 and 7, the dark light reflected by the mold frame 300 may be transmitted differently depending on the distance between the mold frame 300 and each of the side surfaces 10s2, 10s3, 10s4 of the light guide plate 10. In this case, as the distance between the mold frame 300 and each of the side surfaces 10s2, 10s3, 10s4 of the light guide plate 10 decreases, the possibility of the reflected dark light being visually observed through the display surface may increase.

In the case of the present embodiment, the second color conversion tape 420_1 may be formed over the entire surface of the mold frame 300 to reduce black patterns visually observed at the edge of the display surface, and the phosphorus density of the second color conversion tape 420_1 may be adjusted depending on the distance between the mold frame 300 and each of the side surfaces 10s2, 10s3, and 10s4 of the light guide plate 10, thereby minimizing differences in area between the black patterns visually observed at the edge of the display surface.

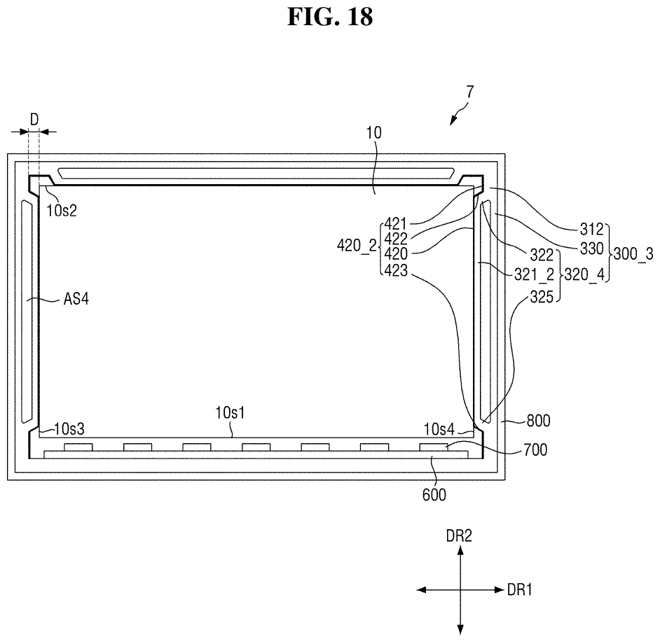

FIG. 18 is a schematic plan view of a display device according to still another embodiment of the present disclosure.

Referring to FIG. 18, a display device 7 according to the present embodiment differs from the display device 4 of FIG. 13 in that a second color conversion tape 420_2 is applied to the display device 4 of FIG. 13.

More specifically, the second color conversion tape 420_2 may be formed over the entire inner surface of a mold frame 300_3 (e.g., the surface adjacent to the light guide plate 10). The second color conversion tape 420_2 may include a first portion 420, a second portion 421, a third portion 422, and a fourth portion 423. In the second color conversion tape 420_2, as shown in FIG. 18, the density of phosphor may be adjusted depending on the space between the first sub-frame 320_4 and each of the side surfaces 10s1, 10s2, 10s3, and 10s4 of the light guide plate 10.

The first portion 420 of the second color conversion tape 420_2 may be between the first section 321_2 of the first sub-frame 320_4 and each of the side surfaces 10s2, 10s3, and 10s4 of the light guide plate 10. The second portion 421 of the second color conversion tape 420_2 may be between the main frame 312 and each of the side surfaces 10s1, 10s2, 10s3, and 10s4 of the light guide plate 10. The third portion 422 of the second color conversion tape 420_2 may be between the second section 322 of the first sub-frame 320_4 and each of the side surfaces 10s2, 10s3, and 10s4 of the light guide plate 10. The fourth portion 423 of the second color conversion tape 420_2 may be between the fifth section 325 of the first sub-frame 320_4 and each of the side surfaces 10s2, 10s3, and 10s4 of the light guide plate 10.

The phosphor density of the first portion 420 of the second color conversion tape 420_2 may be greater than the phosphor density of each of the second portion 421, third portion 422 and fourth portion 423 of the second color conversion tape 420_2. The phosphor density of each of the third portion 422 and fourth portion 423 of the second color conversion tape 420_2 may have a value between the phosphor density of the first portion 420 of the second color conversion tape 420_2 and the phosphor density of the second portion 421 of the second color conversion tape 420_2.

In the case of the present embodiment, the second color conversion tape 420_2 may be formed over the entire surface of the mold frame 300_3 to reduce black patterns visually observed at the edge of the display surface, and the phosphorus density of the second color conversion tape 420_2 may be adjusted depending on the distance between the mold frame 300_3 and each of the side surfaces 10s1, 10s2, 10s3, and 10s4 of the light guide plate 10, thereby reducing or minimizing differences in area between the black patterns visually observed at the edge of the display surface.

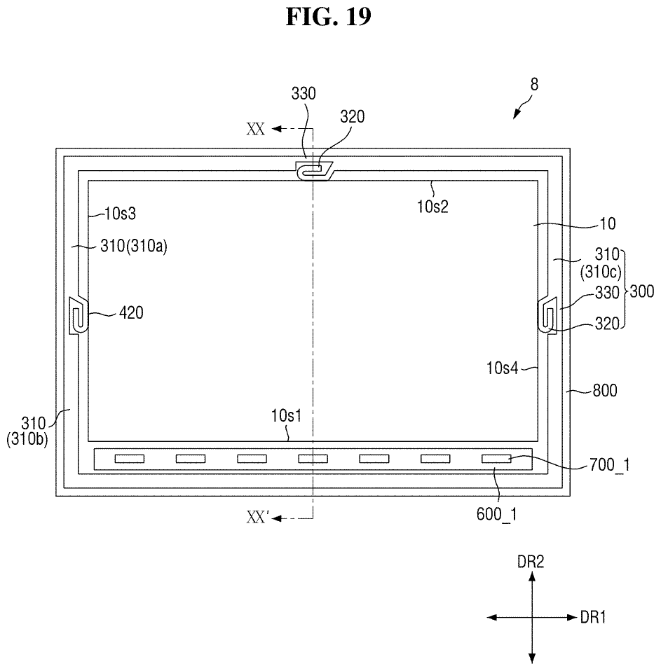

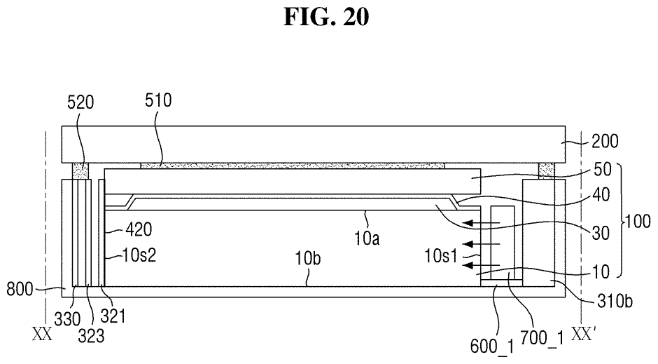

FIG. 19 is a schematic plan view of a display device 8 according to still another embodiment of the present disclosure, and FIG. 20 is a cross-sectional view taken along the line XX-XX′ in FIG. 19.

Referring to FIGS. 19 and 20, in a display device 8 according to the present embodiment, a light source 700_1 may be a side light emitting diode, in which light is emitted from a side surface of the light source 700_1.

For example, a circuit board 600_1 may be on the upper surface of the housing 800, and the light source 700_1 may be on the upper surface of the circuit board 600_1. The light source 700_1 may emit light in the lateral direction.

As used herein, the terms “use”, “using”, and “used” may be considered synonymous with the terms “utilize”, “utilizing”, and “utilized”, respectively. Further, the use of “may” when describing embodiments of the present disclosure refers to “one or more embodiments of the present disclosure”.

As used herein, the terms “substantially”, “about”, and similar terms are used as terms of approximation and not as terms of degree, and are intended to account for the inherent deviations in measured or calculated values that would be recognized by those of ordinary skill in the art.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Although various embodiments of the present disclosure have been disclosed for illustrative purposes, those skilled in the art will appreciate that various modifications, additions and substitutions are possible, without departing from the scope and spirit of the present disclosure as defined by the following claims and equivalents thereof.

What is claimed is:

1. A display device, comprising:
a light guide plate; and
a mold frame surrounding the light guide plate in a plan view,
wherein the mold frame comprises:
a first sub-frame;
a second sub-frame; and
a main frame comprising:
a first main portion connected to a first end of the first sub-frame and a first end of the second sub-frame and extending along a first side surface of the light guide plate along a first direction; and
a second main portion connected to a second end of the second sub-frame and extending along the first side surface of the light guide plate opposite the first direction,
the first sub-frame and the second sub-frame being parallel and spaced apart from each other with a space therebetween.

2. The display device of claim 1, wherein the light guide plate comprises glass and/or quartz.

3. The display device of claim 1,
wherein the first sub-frame comprises a first section facing the first side surface of the light guide plate and a second section connecting the first section and the first main portion.

4. The display device of claim 3,
wherein a side surface of the first section facing the first side surface of the light guide plate is closer to the light guide plate in a second direction normal to the first direction, compared to a side surface of the main frame facing the light guide plate.

5. The display device of claim 4, wherein:
the first section further comprises a chamfered surface connecting the side surface of the first section facing the first side surface of the light guide plate and an upper surface of the first section,
wherein a slope of the chamfered surface of the first section is between a slope of the side surface of the first section facing the first side surface of the light guide plate and a slope of the upper surface of the first section.

6. The display device of claim 4, further comprising a color conversion tape attached to the first sub-frame and between the first section and the light guide plate.

7. The display device of claim 6, wherein the color conversion tape comprises a yellow phosphor.

8. The display device of claim 6,
wherein the color conversion tape is attached to an entirety of a side surface of the mold frame facing the light guide plate.

9. The display device of claim 7,
wherein a density of the yellow phosphor in the color conversion tape in an area where the color conversion tape is attached to the first section is higher than a density of the yellow phosphor in the color conversion tape in an area where the color conversion tape is attached to the main frame.

10. The display device of claim 4,
wherein first sub-frame further comprises a third section connecting the first section of the first sub-frame to the second main portion.

11. The display device of claim 10, further comprising:
a cushion member between the first sub-frame and the second sub-frame.

12. The display device of claim 1,
wherein the mold frame forms a rectangular frame shape in a plan view.

13. The display device of claim 1,
wherein a planar width of the main frame is greater than a planar width of the first sub-frame.

14. The display device of claim 1,
wherein the mold frame comprises a light blocking material.

15. The display device of claim 1, further comprising:
a light source at a second side surface of the light guide plate; and
a wavelength conversion layer on an upper surface of the light guide plate.

16. The display device of claim 15,
wherein the light source provides blue light to the light guide plate, and
the wavelength conversion layer comprises a plurality of first wavelength conversion particles to convert the blue light into red light and a plurality of second wavelength conversion particles to convert the blue light into green light.

17. A display device, comprising:
a light guide plate;
a mold frame having a rectangular frame shape and surrounding the light guide plate in a plan view;
a light source between a first side surface of the light guide plate and the mold frame; and
a color conversion tape between a second side of the light guide plate and the mold frame,
wherein the mold frame comprises a main portion extending along the second side of the light guide plate and a sub-portion connected to the main portion and protruding toward the second side of the light guide plate with respect to the main portion,
the light source being to provide blue light to the light guide plate, and
the color conversion tape being attached to the sub-portion of the mold frame.

18. The display device of claim 17,
wherein the color conversion tape comprises a yellow phosphor.

19. The display device of claim 18,
wherein the color conversion tape converts the blue light into yellow light.

20. The display device of claim 17,
wherein the color conversion tape integrally extends along a second side surface and a third side surface of the light guide plate.
